(19) United States
(12) Patent Application Publication
(10) Pub. No.: US 2003/0146318 A1
(43) Pub. Date: Aug. 7, 2003

(54) Roll crusher teeth having hard compact material inserts

(76) Inventor: Gary J. Condon, Irwin, PA (US)

Correspondence Address: Kevin P. Weldon, Kennametal Inc., P.O. Box 231, Latrobe, PA, 15650, US

(21) Appl. No.: 10/067,021

(22) Filed: Feb. 4, 2002

(51) Int. Cl. B02C 4/30

(52) U.S. Cl. 241/236; 241/294

(57) ABSTRACT

The present invention provides a rock crusher tooth design which when exposed to material flows during operation of the rock/material crusher will increase the wear life of the tooth by resisting wear caused by a material flow across, onto, and around the tooth. It is a general object of the present invention to provide a rock crusher with a plurality of teeth formed integrally therein. The tooth has a design that significantly improves the wear resistance of each tooth. The tooth structure includes a plurality of hard material compact inserts integrated within the tooth structure. The compact inserts are integrally formed with the teeth into unitary structures. In an embodiment of the invention, hard abrasive material, such as tungsten-carbide compact inserts, are appropriately positioned in a steel cast tooth mold, the steel flows into spaces between and around the tungsten-carbide inserts trapping them in a steel matrix. The casting method results in an integral unitary steel tooth.

### BACKGROUND OF THE INVENTION

1. Field of the Invention

The present invention relates to crushing members used in pulverizers of the type in which material is pulverized between crushing surfaces. Pulverizers of this type include parallel rolling drum pulverizers/crushers, cone crushers, ring roll mills, vertical roller mills and edge runners.

2. Background

Heretofore, various materials such as iron ore, coal, coke, graphite, converter slag, blast furnace slag, limestone, clinker, rock, etc. have been crushed by parallel rolling drum pulverizers/crushers, cone crushers, ring roll mills, vertical roll mills, etc. The pulverization principle involved in the functioning of these pulverizers will be described in use with a parallel rolling drum rock crusher.

A pair of rolling drums having cylindrical surfaces make turns to effect pulverization of the material to be pulverized by compression and shearing exerted between parallel horizontal rolling drums mounted in parallel. U.S. Pat. No. 4,733,828, to Potts, discloses a parallel rolling drum rock crusher.

Although steel teeth possess good strength, their abrasion and impact resistance generally is not adequate to permit pulverization of hard material without damage to the tooth bit. Further, when used with abrasive material, crusher teeth made from a uniform steel alloy must be frequently replaced.

Consequently, it is conventional in the prior art to provide a layer of hardfacing to build up, or re-construct teeth that have been worn. Hardfacing is a decades old operation. Hardfacing materials are applied by melting the hardfacing material and applying the material over the surfaces of the tooth. The hardfacing wear-resistant material is typically applied to teeth by a metallic electro-welding electrode out in the field. The hardfacing materials applied in the field typically include a percentage of tungsten dispersed in an alloy that does not break down in the electro-welding process. The proper application of hardfacing material to steel tooth bits requires considerable skill on the part of the welder.

Both the steel and hardfaced steel do not take into consideration areas of a tooth that are more prone to wear because they are subject to greater material flow, material flow forces, and material flow loads. Some areas of the teeth are also subject to large impact forces that may arise when rock is fed from above into the crusher.

What is needed, therefore, is a device for reducing wear of components on apparatus surfaces most frequently exposed to impact and abrasion during operation of the crusher. Particularly, what is needed is a device for reducing wear of components of crushers caused by a material flow of aggregate during operation.

The present invention overcomes and avoids such problems in the prior art.

### SUMMARY OF THE INVENTION

It is an object of the present invention to provide a crusher assembly including a tooth design that, when exposed to material flows during operation of the rock/material crusher, will increase the wear life of the teeth by resisting wear caused by a material flow across, onto, and around the tooth.

It is a general object of the present invention to provide a rock crusher with a plurality of teeth formed integrally thereon. Each of the teeth has a design that significantly improves the wear resistance of each tooth.

It is a general object of the present invention to provide an improved rock crusher tooth having an improved tooth structure. The tooth structure includes a plurality of hard material compact inserts integrated within the tooth structure. The compact inserts are formed integral with the teeth in unitary structures. The compact inserts on the teeth are positioned to protect the tooth so that the surfaces of the tooth are shielded from abrasive wear.

The object of the present invention is achieved by providing a rock crusher tooth having a body and at least one wear-resistant hard material compact insert integral with the tooth body. In an embodiment of the invention, hard abrasive material such as tungsten-carbide compact inserts are appropriately positioned in a steel cast tooth mold so that the steel flows into spaces between and around the tungsten-carbide inserts trapping them in a steel matrix. The casting method results in an integral unitary steel tooth.

In the present invention, the outer end of a first rod inserted into a first bore formed in the tooth may extend a distance beyond a surface of the tooth body. The first rod protects the housing material forming the second bore from being worn away by material flow, “washed out.” The tooth body material is typically made from a softer ferrous material than the insert rods which are made from cemented tungsten carbide, for instance. The housing that forms the insert receiving bores erodes quicker than the insert rods. Each rod in the applicant's invention is positioned to provide primary contact with the material being crushed, reducing wear on the housing.

Still another object of the present invention is to provide a design for reducing wear of components of crushers during operation and a method for manufacturing wear reducing components which are easy to manufacture, use and to practice, and which are cost effective for their intended purposes.

It is an object of the present invention to reduce the frequency of roller tooth maintenance required in the operation of rock crushers. It is believed that the saving of expenses resulting from less maintenance labor, cost of replacement teeth and down time exceeds the additional expense in constructing teeth with compact inserts integrally formed therein.

These and other objects, features, and advantages of such components for reducing wear by a material flow will become apparent to those skilled in the art when read in conjunction with the accompanying following detailed description, drawing figures, and appended claims.

### BRIEF DESCRIPTION OF THE DRAWINGS

FIG. 1 is a schematic side view of a parallel rolling drum rock crusher illustrating the general elements of this invention.

FIG. 2 is a top view of FIG. 1 illustrating teeth on the parallel rolling drums.

FIG. 3 is a perspective view of a single tooth of a first embodiment of the present invention.

FIG. 4 is a side view of the tooth shown in FIG. 3.

FIG. 5 is a front view of the tooth shown in FIG. 3.

FIG. 6 is a perspective view of a single tooth of a second embodiment of the present invention.

### DETAILED DESCRIPTION OF THE INVENTION

Referring to FIG. 1, the present invention provides a rock crusher 10 comprising: a framed housing 14, a pair of rolling drums 16 mounted for rotation about parallel axes and at a predetermined spacing from each other to define between them a throat 18; each said rolling drum carrying a plurality of radially projecting longitudinally extending teeth, the teeth of each rolling drum being angularly spaced apart providing clearance therebetween; motor means 20 are connected to rotate said rolling drums16 in timed synchronous fashion but in opposite directions so that the teeth 30 of the opposed rolling drums 16 pass in pairs through said throat at the same time; and means for directing rock/material 12 into said throat 18 to be crushed and passed through said throat by said rotating teeth 30.

The supply of material into means for directing 12 is controlled by well-known material conveying means, such as an endless conveyor or screw conveyor or other well-known methods in the industry such as a gravity feed hopper with a flow gate. The material flows by gravity and exits the directing means 12 into the rock crusher 10. The material is pulverized and crushed between the adjacent rolling drums 16.

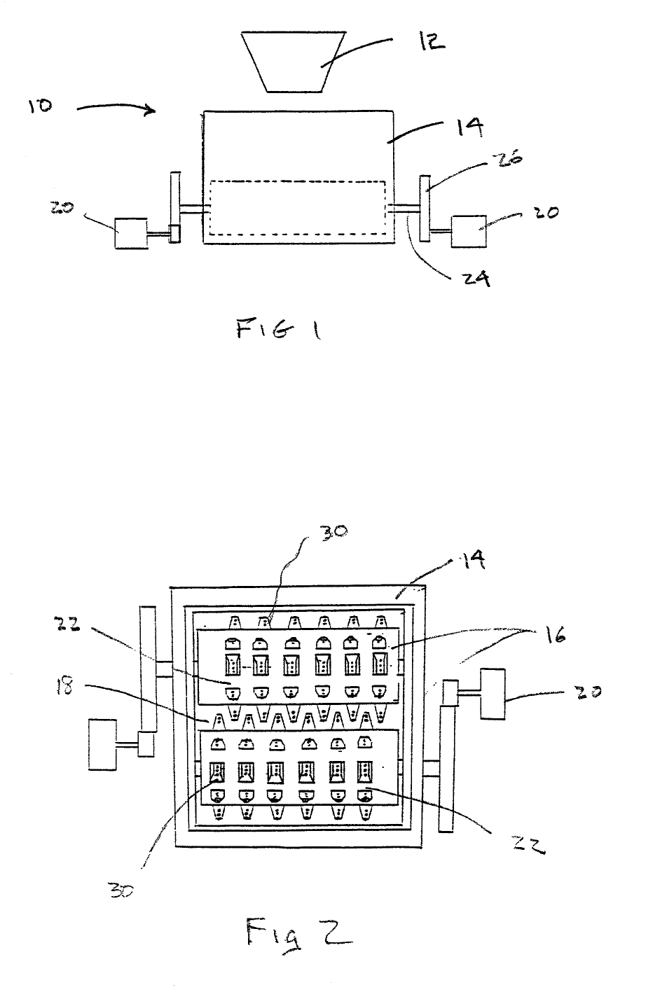

A throat 18 is defined as the opening between the rolling drums 16. The length and width of the throat are defined by the axial length of the rolling drums 16 and the uniform distance between the parallel rolling drums, respectively. The teeth on adjacent rolling drums mesh together in the throat 18 formed between the two rolling drums as best seen in FIG. 2. Material can only pass through the throat 18 if it has a size smaller than the gaps between the intermeshing teeth. For each rolling drum there is provided a shaft 24 connected to the motor means 20 by drive means 26 and mounted on support bearing assemblies and extending through bearing members, and as are well-known in the art, the shafts are in parallel relation throughout the length of the crusher housing.

Each shaft 24 is rotatably mounted to a respective motor means 20 which may be controlled through a separate control breaker panel (not shown). The shafts 24 are freely rotatable in either direction during operation of the rock crusher assembly 10; however, the shafts 24 are preferably rotated in opposite or counter-rotating direction with respect to each other, feeding the raw material into the throat of the crusher 18.

As material is moved toward the throat by the rolling drums, large sized material that bridges the width of the throat and across adjoining drum teeth are broken and ground apart. The throat, drum and teeth are designed for crushing, fracturing, breaking up and reducing in size large aggregate into smaller sizes. Material that has a size that is too large to exit out the throat will float adjacent the throat until it is pulverized by the intermeshing teeth, as well-known in the art.

On the rolling drums 16 of this invention, as shown in FIG. 2, a plurality of teeth 30 are illustrated as being positioned about the circumference and axial length of the rolling drums. The size of the teeth 30, angular spacing 22 between teeth, spacing in the longitudinal direction of the drum and clearance/gaps between the intermeshing teeth of the two rolling drums, determine the final resulting size of the aggregate product. The tooth patterns on the rolling drums are routinely designed by ordinary artisans in the industry applying well-known design principles. The tooth pattern on the cooperating rolling drums 16 can be designed to achieve a desired pulverized aggregate material size.

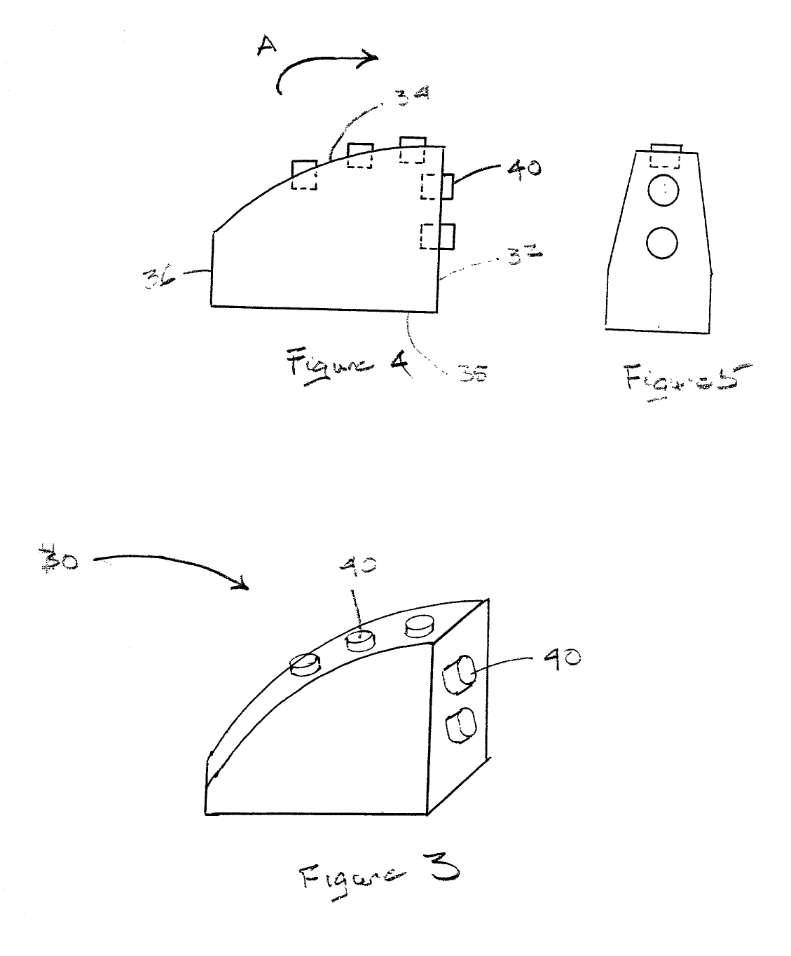

FIG. 3 illustrates a crusher tooth of the present invention. The tooth has the same general shape of prior art teeth for rolling drum crushers. The present invention is distinguishable from the prior art teeth by its incorporation of wear-resistant hard material compact inserts 40 positioned on the lead working surface 32 and to top surface 34. The compact inserts are located on the tooth so that the surfaces of the tooth body are generally shielded from abrasive wear. It is contemplated that the size, shape and position of the hard material inserts along the tooth may differ from that shown in the disclosed embodiment depending on the composition (e.g., limestone) and size of the aggregate material being pulverized/crushed. The compact inserts 40 can be made of cemented tungsten carbide or another wear resistant composition employed to reduce wear on equipment in similar applications in the mining, construction or aggregate industry.

The tooth has a bottom surface 38 that is attached to the circumferential surface of the rolling drum. The surface may be either flat, as shown in FIG. 4, or have a radius of curvature that corresponds to the radius of curvature of the rolling drum. The bottom surface of the tooth is either welded, or attached by other methods well-known in the industry, to the rolling drum.

The orientation of the tooth with respect to the direction of rotation of the rolling drum is shown in FIG. 4, when attached onto a rolling drum the tooth rotates in the direction indicated by arrow “A”. The tooth comprises a tooth body and at least one hard compact insert made from a wear resistant composition. The lead working surface 32 on the teeth make contact with the raw material. The compact inserts 40 are positioned on the lead working surface 32. The insert rods on the tooth are positioned on the tooth in areas of a tooth that are more prone to wear because they are subject to greater material flow, material flow forces, and material flow loads. As can be appreciated by an artisan, when the drums rotate, the material lead work surface 32 is the primary surface that contacts and pushes material in the direction of rotation of the drum into the throat 18 and is subject to substantial wear. Further, the rock/material is compressed and pulverized by the leading working surface of the rolling drums 16.

The raw material is guided by the directing means 12 onto the rolling drums in the crusher. The tooth has a plurality of exposed surfaces that wear during operation of the rock crusher. The top surface 34 of the tooth is subject to impact forces that may arise when rock is fed into the crusher 10. The top surface 34 of the tooth may be provided with a compact insert 40 that, in addition to having wear-resistance properties, may be designed from a more ductile composition to reduce the potential of fracture due to impact forces applied to the top surface of the tooth. The top surface 34 on each tooth assists in compressing and pulverizing material in the throat 18 between the rolling drums 16. FIG. 6 discloses a second alternative embodiment wherein a compact insert 40 is centrally positioned at the corner intersection of the top surface 34 and leading working surface 32. Such a compact insert substantially reduces wear along this edge of the tooth. This edge portion in the prior art has been an area of accelerated wear in comparison to the remaining surface areas of the tooth.

With reference to FIG. 4, the height that the compact inserts 40 extend beyond the body top surface 34 of the surface should desirably be about three (3) mm or more. If it is less than two (2) mm, generally it is difficult to ensure the longest life of the tooth surfaces 32 and 34, irrespective of their materials. The wear resistant composition used to make compact inserts is expensive. If the height it extends beyond the surfaces and its overall size is too great, however, the proportion of the wear resistant compact insert to the whole of the tooth will increase, resulting in higher cost. The height the compact insert extends beyond surfaces and its size, accordingly, should desirably be limited to below nine (9) mm. Preferably, the height that the compact insert extends beyond the surfaces of the tooth is within the range of 3-8 mm.

The height dimension that each compact insert extends beyond the surfaces on a tooth should basically be the same. However, even if in the newly manufactured product, there are some differences in height among inserts on a common surface. The compact inserts 40 having different heights on that same surface will wear relatively rapidly upon starting of the operation, producing equivalent heights. Thus, no particularly serious problem will result if the compact inserts do not initially have equivalent heights.

The cumulative surface area of the exposed end of all the cylindrical compact inserts 40 on either the top surface 34 or lead working surface 32 is desired to be a significant amount of area in comparison to the top surface area and lead working surface area, respectively. This is necessary; otherwise, the significance of providing the wear resistant compact inserts 40 would lessen, resulting in a reduction in the durability of the teeth on the rolling drums. In such a design, the wear resistance of the wear resistant compact inserts substantially governs the life of the tooth.

The impact inserts are formed to be integral with the tooth in unitary structures. The tooth 30 can be molded beforehand, with the compact inserts fitted and stuck in a bore formed in the tooth to receive cylindrical compact inserts 40, the compact inserts can be connected to the tooth by an adhesive, soldering, press fit, or other mechanical means. Further, it should be noted that the compact inserts are not limited to being just cylindrical in shape, but may be of other equivalent geometrical shapes.

The tooth may be integrally formed by well-known casting methods by first placing compact inserts in their proper form in a mold and then pouring a molten metal into the mold. According to this invention, a steel exhibiting acceptable hardness and impact toughness is prepared generally according to standard molten steel casting procedures well known in the art. In yet another embodiment of the present invention, the molten steel may also be cast to form a composite wear resistant material according to the procedure described in U.S. Pat. No. 5,094,923, incorporated in its entirety herein by reference. If necessary, the cast metal may then be subjected to further heat treatment to impart thereto desirable mechanical properties.

In another preferred casting process, in addition to the placement of compact inserts positioned for cast molding as discussed immediately above, the distal ends of molds are lines with broken pieces and particles of hard abrasive material such as cemented tungsten-carbide. Steel is cast in the mold and flows into spaces between and around the pieces and particles, trapping them in a steel matrix.

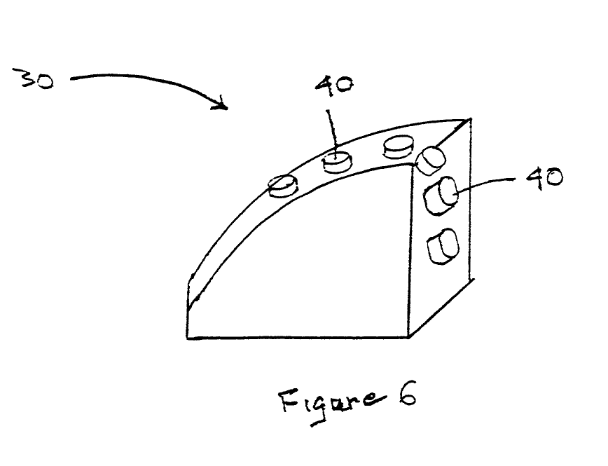

The tooth pattern depicted in FIG. 2 and tooth shape illustrated in FIGS. 3-5 are merely representative of a tooth pattern for a crusher and to help disclose the present invention, and is not intended to limit the scope of application of the present invention.

The novel features of this invention and the invention itself, both in structure and operation, are best understood from the accompanying drawings considered in connection with the accompanying description of the drawings.

What is claimed is:

1. A crusher comprising:
a framed housing;
a pair of rolling drums for rotation about parallel axes and at a predetermined spacing from each other to define between them a throat, said throat having a width and a length;
each said rolling drum carrying a plurality of radially projecting longitudinally extending teeth, said teeth projecting radially to at least a part of the of the width of said throat;
motor means connected to rotate said rolling drums in timed synchronous fashion but in opposite directions, the teeth of the opposed rolling drums being in register so as to pass through said throat; and
a directing means for directing rock into said throat to be fractured by said rotating teeth into fragments of a size sufficiently small to pass between said rolling drums.

2. A crusher as claimed in claim 1 wherein each of said teeth include at least one compact insert of hard wear resistant composition.

3. A crusher as claimed in claim 1 wherein each of said teeth has a top surface and leading working surface.

4. A crusher as claimed in claim 3 wherein both said top surface and said leading working surface have at least one compact insert of hard wear resistant composition.

5. A crusher as claimed in claim 4 wherein said teeth are formed by casting, said casting includes first placing said compact inserts in a mold and then pouring a molten metal into the mold.

6. A crusher as claimed in claim 1 wherein said teeth have at least one exposed surface and each of said teeth include at least one compact insert having a hard wear resistant composition.

7. A crusher as claimed in claim 6 wherein the compact insert extends to a height greater than 3 mm beyond the exposed surfaces of the tooth.

8. A crusher as claimed in claim 6 wherein the compact insert extends to a height beyond the exposed surfaces of the tooth within the range of 3-8 mm.

9. A crusher as claimed in claim 6 wherein the compact insert extends to a height less than 9 mm beyond the exposed surfaces of the tooth.

10. A crusher tooth comprising:
a tooth body,
wherein said tooth body includes at least one compact insert of hard wear resistant composition.

11. A crusher as claimed in claim 10 wherein said tooth body has a top surface and leading working surface.

12. A crusher as claimed in claim 11 wherein both said top surface and said leading working surface have at least one compact insert of hard wear resistant composition.

13. A crusher as claimed in claim 10 wherein said tooth is formed by casting, said casting includes first placing said compact inserts in a mold and then pouring a molten metal into the mold.

14. A crusher as claimed in claim 10 wherein said tooth has at least one exposed surface and said tooth includes at least one compact insert having a hard wear resistant composition.

15. A crusher as claimed in claim 14 wherein the compact insert extends to a height greater than 3 mm beyond the exposed surfaces of the tooth.

16. A crusher as claimed in claim 14 wherein the compact insert extends to a height beyond the exposed surfaces of the tooth within the range of 3-8 mm.

17. A crusher as claimed in claim 14 wherein the compact insert extends to a height less than 9 mm beyond the exposed surfaces of the tooth.
